(19) United States
(12) Patent Application Publication
(10) Pub. No.: US 2025/0151177 A1
(43) Pub. Date: May 8, 2025

(54) INDUCTION SLAB HEATER USING PWM ZONE HEATING CONTROL WITH SELECTABLE INDUCTION FREQUENCY

(71) Applicant: AJAX TOCCO MAGNETHERMIC CORPORATION, Warren, OH (US)

(72) Inventors: David A. Lazor, Girard, OH (US); Jeffery Phillip Deeter, Warren, OH (US); Anthony Dellapenna, Canfield, OH (US)

(73) Assignee: AJAX TOCCO MAGNETHERMIC CORPORATION, Warren, OH (US)

(21) Appl. No.: 18/936,377

(22) Filed: Nov. 4, 2024

Related U.S. Application Data
(60) Provisional application No. 63/547,225, filed on Nov. 3, 2023.

(51) Int. Cl. H05B 6/06; H05B 6/44

(52) U.S. Cl. CPC H05B 6/06; H05B 6/44

(57) ABSTRACT

An induction slab heating system is provided. In one form, it has a coil having a plurality of sections and a plurality of power inverters, each power inverter corresponding to at least one section of the plurality of sections of the coil to define a plurality of zones of the coil. A plurality of magnetic flux concentrators are positioned around the coil. The system also includes a controller to cause the system to detect a slab having a geometry positioned in the coil, retrieve a heating recipe for the slab based on the geometry of the slab, implement a heating process based on the heating recipe, and selectively adjust at least one of power, heating time or frequency of the plurality of zones of the coil based on the heating recipe.

The present application claims the benefit of and priority to U.S. Provisional Application Ser. No. 63/547,225, filed Nov. 3, 2023, entitled, “Induction Slab Heater Using PWM Zone Heating Control with Selectable Induction Frequency,” which is incorporated herein by reference in its entirety.

### TECHNICAL FIELD

The present exemplary embodiments relate, in at least one form, to induction slab heating systems. However, the implementations are not limited thereto.

### BACKGROUND

In heretofore known processes involving the heating of slabs of metal, there is little or no adjustability and/or adaptability in the process. There is typically a single heating zone controlled by a single control system.

### BRIEF DESCRIPTION

In one aspect of the presently described embodiments, an induction slab heating system comprises a coil having a plurality of sections; a plurality of power inverters, each power inverter corresponding to at least one section of the plurality of sections of the coil to define a zone of a plurality of zones of the coil; a plurality of magnetic flux concentrators positioned around the coil; and, a controller comprising at least one processor and at least one memory having stored therein code or instructions that, when executed, cause the system to: detect a slab having a geometry positioned in the coil; retrieve a heating recipe for the slab based on the geometry of the slab; implement a heating process based on the heating recipe; and, selectively adjust at least one of power, heating time or frequency of the plurality of zones of the coil based on the heating recipe.

In another aspect of the presently described embodiments, the heating recipes are predetermined based on simulation or testing data.

In another aspect of the presently described embodiments, the slab is moved into the coil.

In another aspect of the presently described embodiments, the coil is moved to surround the slab.

In another aspect of the presently described embodiments, the heating recipe corresponds to a heating profile for the slab.

In another aspect of the presently described embodiments, the heating profile generates uniform temperature across the slab.

In another aspect of the presently described embodiments, the heating profile generates a temperature gradient across the slab.

In another aspect of the presently described embodiments, selectively adjusting at least one of power, heating time or frequency of the plurality of zones of the coil comprises selectively adjusting at least one of power, heating time or frequency of the plurality of zones of the coil in each of the plurality of the zones of the coil.

In another aspect of the presently described embodiments, selectively adjusting the frequency of the plurality of zones of the coil comprises selectively adjusting the frequency to maintain all the plurality of the zones of the coil at the same frequency.

In another aspect of the presently described embodiments, the each power inverter is a solid state device.

In another aspect of the presently described embodiments, an induction slab heating method comprises detecting a slab having a geometry positioned in a coil having a plurality of zones; retrieving a heating recipe for the slab based on the geometry of the slab; implementing a heating process based on the heating recipe; and, selectively adjusting at least one of power, heating time or frequency of the plurality of zones of the coil, each power inverter corresponding to one coil section to define a zone of the plurality of zones of the coil, based on the heating recipe.

In another aspect of the presently described embodiments, the method further comprises generating the heating recipe based on simulation or testing data.

In another aspect of the presently described embodiments, the method further comprises moving the slab into the coil.

In another aspect of the presently described embodiments, the method further comprises moving the coil to be positioned around the slab.

In another aspect of the presently described embodiments, the heating recipe corresponds to a heating profile for the slab.

In another aspect of the presently described embodiments, the heating profile generates uniform temperature across the slab.

In another aspect of the presently described embodiments, the heating profile generates a temperature gradient across the slab.

In another aspect of the presently described embodiments, the selectively adjusting at least one of power, heating time or frequency of the plurality of zones of the coil comprises selectively adjusting at least one of power, heating time or frequency of the plurality of zones of the coil in each of the plurality of the zones of the coil.

In another aspect of the presently described embodiments, the selectively adjusting the frequency of the plurality of zones of the coil comprises selectively adjusting the frequency to maintain all the plurality of the zones of the coil at the same frequency.

In another aspect of the presently described embodiments, a non-transitory computer readable medium has stored thereon code or instructions that, when executed by a processer, cause a system to detect a slab having a geometry positioned in a coil having a plurality of zones, retrieve a heating recipe for the slab based on the geometry of the slab, implement a heating process based on the heating recipe, and selectively adjust at least one of power, heating time or frequency of the plurality of zones of the coil, each power inverter corresponding to at least one coil section to define a zone of the plurality of zones of the coil, based on the heating recipe.

### BRIEF DESCRIPTION OF THE DRAWINGS

FIGS. 1A-1D show graphs of voltage, current and power profiles, respectively, achieved implementing the presently described embodiments;

FIG. 2 is an illustration of an example system according to the presently described embodiments;

FIG. 3 is an illustration of an example system according to the presently described embodiments;

FIG. 4 is an illustration of an example system according to the presently described embodiments;

FIG. 5 is an illustration of an example system according to the presently described embodiments;

FIG. 6 is an illustration of an example system according to the presently described embodiments;

FIGS. 7A and 7B are illustrations of an example system according to the presently described embodiments; and,

FIGS. 8A-8F illustrate recipes for example heating processes according to the presently described embodiments.

### DETAILED DESCRIPTION

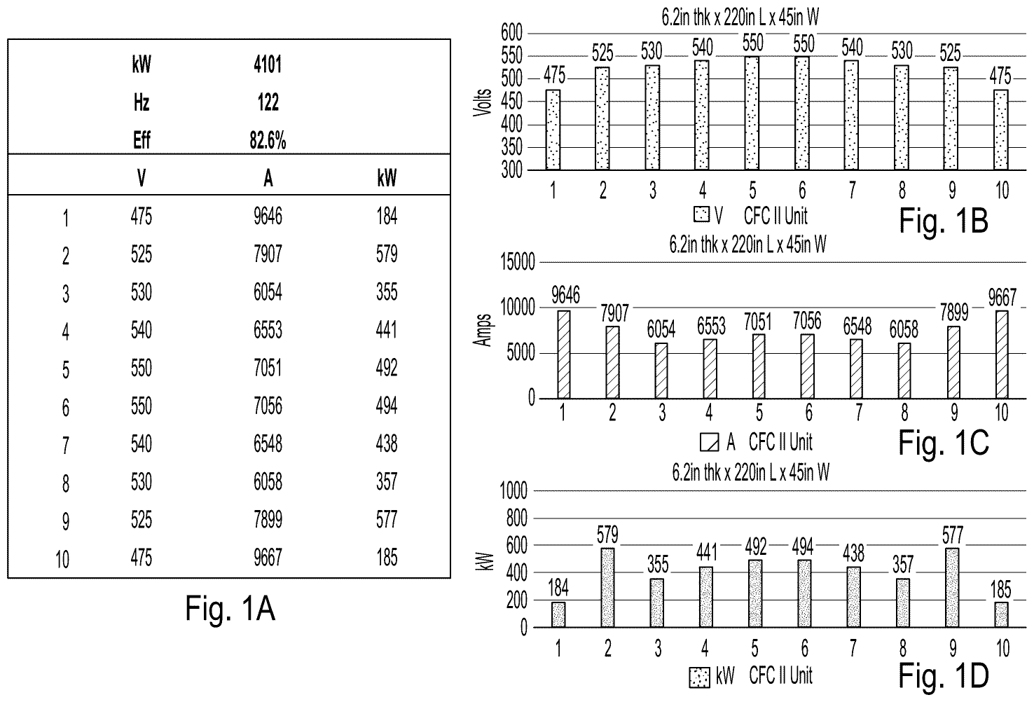

According to the presently described embodiments, an induction slab heater is provided. In at least one form, with reference to FIGS. 1A-1D, the induction slab heater according to the presently described embodiments is able to create and implement a customized heating profile, e.g., on the bases of slab geometry, by adjusting frequency, power (e.g., voltage and/or current), and/or heating time. In FIGS. 1A-1D, the voltage, current, and power profiles for a 6.2-inch thick by 220-inch long by 45-inch wide slab heated using a frequency of 122 Hz are shown. It should be appreciated that heating using a lower frequency (e.g. 62 Hz) results in deep penetration of heat energy while heating using a higher frequency (e.g. 180 Hz) results in more surface heating. In this regard, according to the presently described embodiments, heating may be accomplished using energy in the range of 1 Hz to 5000 Hz.

The adjustability of frequency, power, and/or heating time according to the presently described embodiments has advantages. For example, adjusting these metrics may create a temperature profile of even heating across the width of the slab. In another example, the desired temperature profile may be uneven or includes a gradient, for example, to account for a cold edge of the slab. A time adjustment, in at least one form, will help address a need for heating delay where, for example, the edge of a slab sits on its edge.

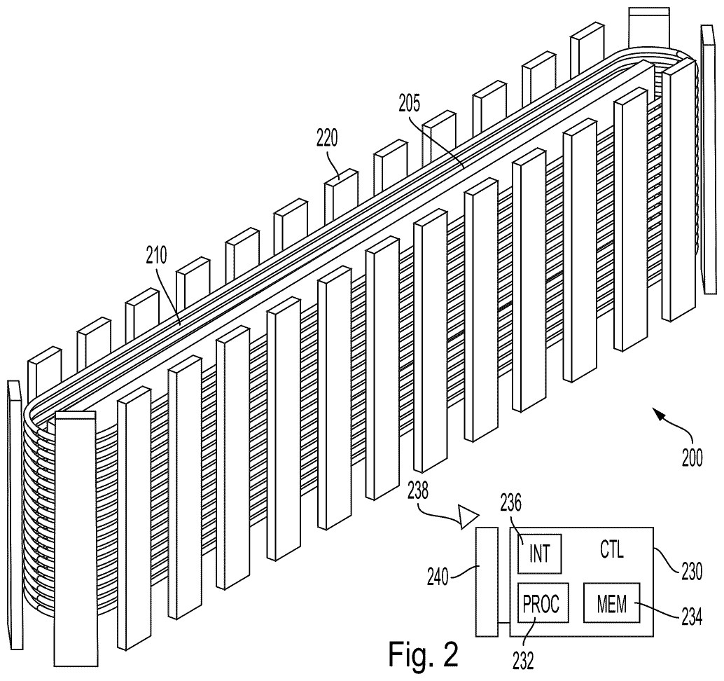

With reference to FIG. 2, an induction slab heating system 200 for heating, for example, a slab 205 is provided. In at least one form, the induction slab heating system 200 according to the presently described embodiments has a coil 210. In at least one form, as will be described in greater detail herein, the coil 210 has a plurality of sections (e.g., a plurality of coil sections, each coil section having turns) and a plurality of power inverters 240. Each power inverter of the plurality of inverters 240 corresponds to at least one section of the plurality of sections of the coil 210 to define a zone, e.g., a heating zone, of the coil. Thus, in at least one form, the coil has a plurality of zones, e.g., a plurality of heating zones. In at least one form, there is one to one correspondence between an inverter and a section to define a zone. In other forms, there is one inverter for one or more sections to define a zone. For any given coil, there could be one to one correspondence between the coil sections and inverters, many to one correspondence between the coil sections and inverters, and/or a combination of both. In at least one form, there may be a zone or zones of a coil defined by multiple inverters per coil section, depending on the application. A plurality of magnetic flux concentrators 220 are positioned around the coil 210.

The system 200 also includes a controller 230 that could take a variety of forms. In at least one example form, as shown, the controller 230 includes at least one processor 232 and at least one memory 234. In at least one form, the controller 230 also includes an interface 236. The memory 234 has stored thereon instructions or code that, when executed by the processor 232, cause the system to perform a variety of functions. In this regard, the system is caused to detect the slab 205 positioned in the coil. It is to be appreciated that the slab 205 has a geometry. In this regard, the system 200 is configured and caused by execution of the instructions or code to not only detect the slab 205 but to also utilize or detect the geometry to retrieve or formulate a heating recipe for the slab 205 based on the geometry of the slab 205. The system 200 then is caused to implement a heating process based on the heating recipe. In this regard, in at least one form, the system 200 selectively adjusts at least one of power, heating time or frequency of the plurality of zones of the coil 210 based on the heating recipe. In at least one form, selectively adjusting at least one of power, heating time or frequency of the plurality of zones of the coil comprises selectively adjusting at least one of power, heating time or frequency of the plurality of zones of the coil in each of the plurality of the zones of the coil. In at least one form, selectively adjusting the frequency of the plurality of zones of the coil comprises selectively adjusting the frequency to maintain all the plurality of the zones of the coil at the same frequency.

It should be appreciated that adjusting the power, in at least form, includes adjusting the input voltage through a variety of techniques which has an impact on the induced current and the resultant power. In at least one form, voltage is adjusted by controlling the pulse width of the inverter firing sequence. In at least one form, voltage can be adjusted or varied on a per zone basis. Heating time can be adjusted using system controls as those of skill in the art will appreciate. In at least one form, heating time can be adjusted manually by a user or by computer control. In at least one form, adjusting the frequency of a zone or zones is achieved by adjusting the frequency of the corresponding inverter or inverters. In at least one form, as noted, the frequency is maintained or adjusted for all zones concurrently to maintain the same frequency in all zones at the same time. However, variations may be implemented where frequency is adjusted on a per zone basis.

As representatively shown, the controller 230 and the plurality of inverters 240 are operative connected to one another. In addition, the controller 230 and the plurality of inverters 240 are operative connected to the coil 210, as representatively shown at 238. Of course, these connections may take a variety of forms as will be appreciated, depending on the environment and specific implementation.

The heating system 200 may also be provided with suitable sensors (e.g., contact thermocouples—not shown) to detect various conditions, such as the temperature of the slab 205 or other components, during the heating process. These detected conditions could then be used to monitor and adjust the process using a feedback loop approach. The detected conditions could also be used to detect undesired results such as overheating, uneven heating, failed heating, . . . , etc. so that appropriate action may be taken.

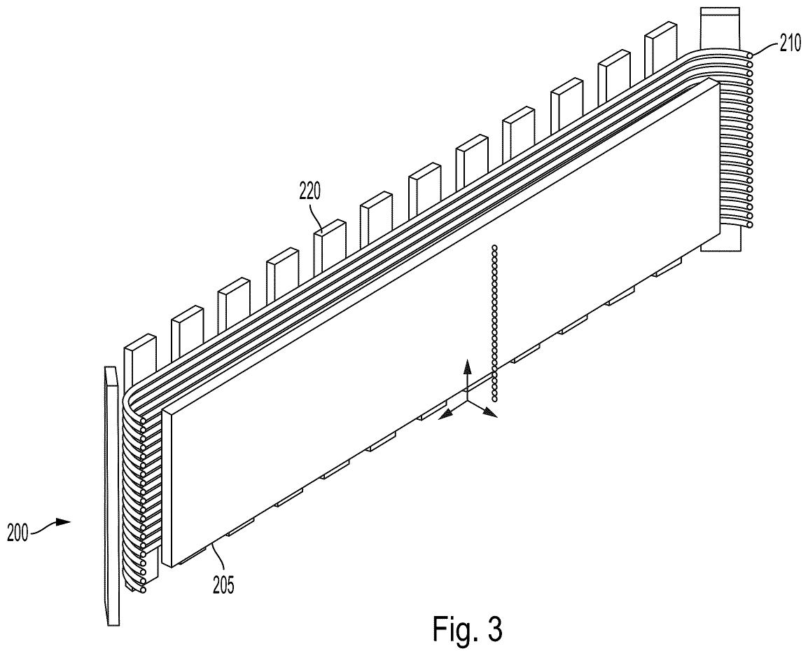

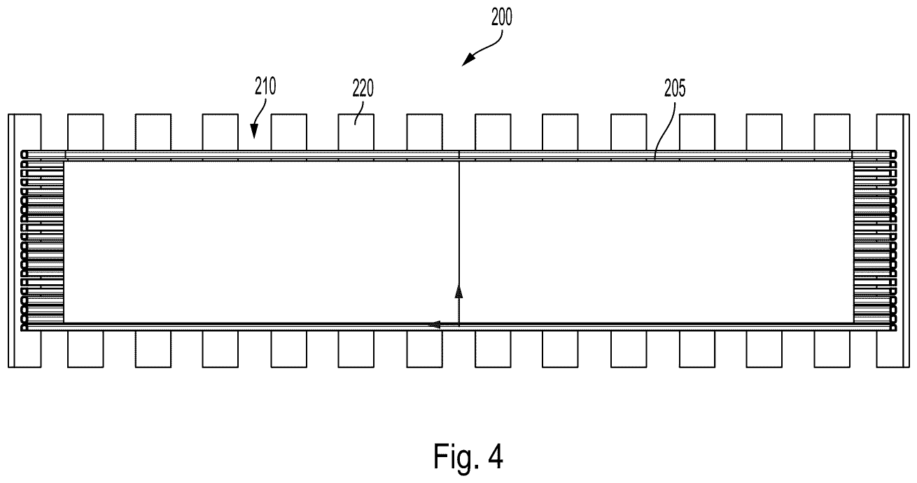

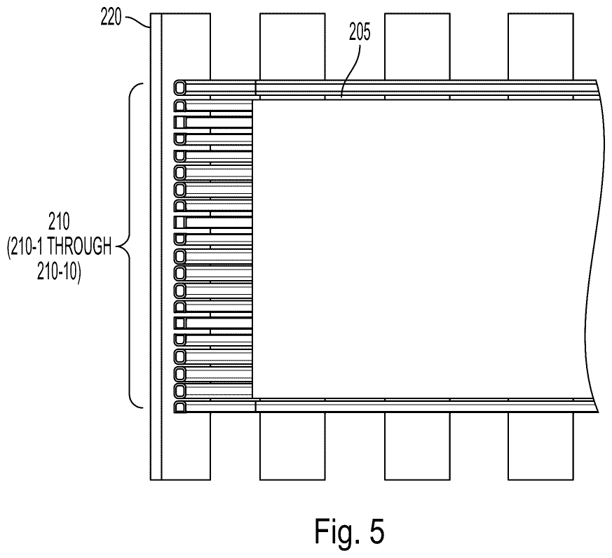

As noted, also shown in FIG. 2 is the slab 205. With continuing reference to FIG. 2 and reference to FIGS. 3-5, it should be appreciated that the slab 205 may be moved relative to the induction slab heating system 200 to be positioned in the coil 210. Alternatively, the induction slab heating system 200 may be moved relative to the slab 205 to position the slab 205 within the coil 210. Although not shown, a variety of systems and/or devices may be implemented to accomplish such relative movement.

FIGS. 2-5 also show that the coil 210 comprises ten (10) coils: 210-1, 210-2, 210-3, 210-4, 210-5, 210-6, 210-7, 210-8, 210-9 and 210-10, each having two (2) turns. As shown, the coil 210 has a total of twenty (20) turns among 10 zones (i.e., 2 turns per zone or coil). Of course, the total number of coils and number of turns for each coil could vary by implementation—these are merely examples.

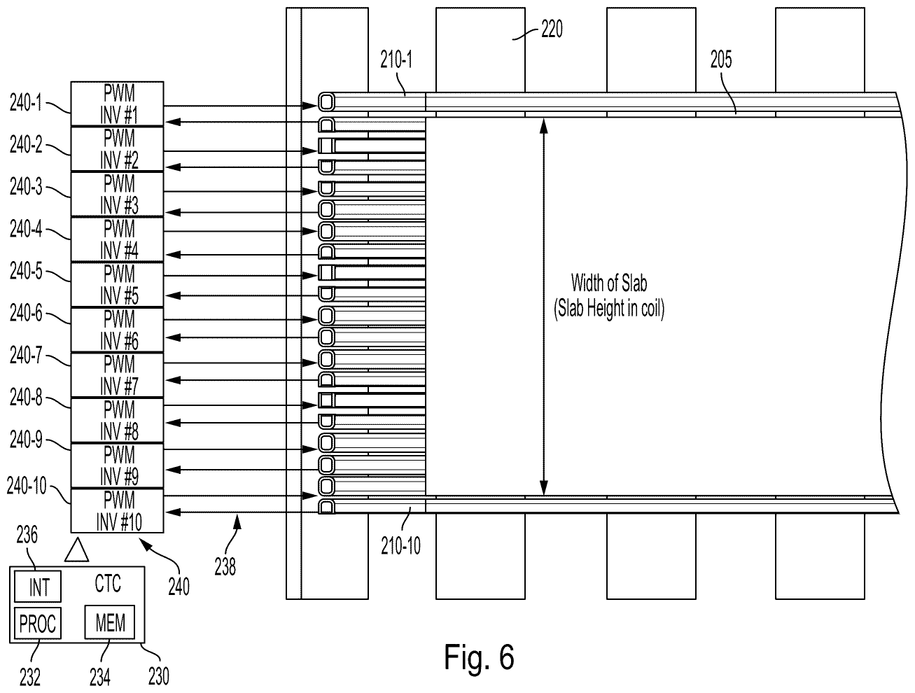

With reference to FIG. 6, power inverters 240 for each coil 210 are shown. As such, in at least one form, power inverters 240-1, 240-2, 240-3, 240-4, 240-5, 240-6, 240-7, 240-8 240-9, and 240-10 connect to and control coils 210-1, 210-2, 210-3, 210-4, 210-5, 210-6, 210-7, 210-8, 210-9 and 210-10, respectively. In this example, for each zone, each coil 210 has, for example, a dedicated pulse width modulation (PWM) power inverter. The power inverters are, in at least one form, solid state devices. The use of solid state devices also allows for the provision of energy in the range of 1 Hz to 5000 Hz—as opposed to more limited ranges. As noted above, it should also be appreciated that one to one correspondence between the coil sections and the inverters is only an example configuration. Other configurations, such as multiple coil sections per inverter (or multiple inverters per coil section) could be implemented.

The PWM inverters can be set to operate at any selectable frequency and can be changed during the heating and soaking process. The ability to change frequency, as noted, is an advantage. In this regard, operating lower frequency during temperature ramping provides a deeper heating into the slab 205 with reduced chance of overheating the surface. Operating at higher frequency during soaking/holding results in more surface heating.

The configuration has many advantages. In this regard, this configuration provides zone heating along the height of the slab in the coil to more easily achieve temperature uniformity. It makes it possible to provide and achieve hotter or cooler top/bottom edges of the slab 205 with respect to the center of the slab 205. No mechanical transformer tap switches are required. No load tuning capacitors or capacitor contactors are required. In this regard, mechanical transformer tap switches and load tuning capacitors or capacitor contactors would be required in other systems where solid state devices are not used.

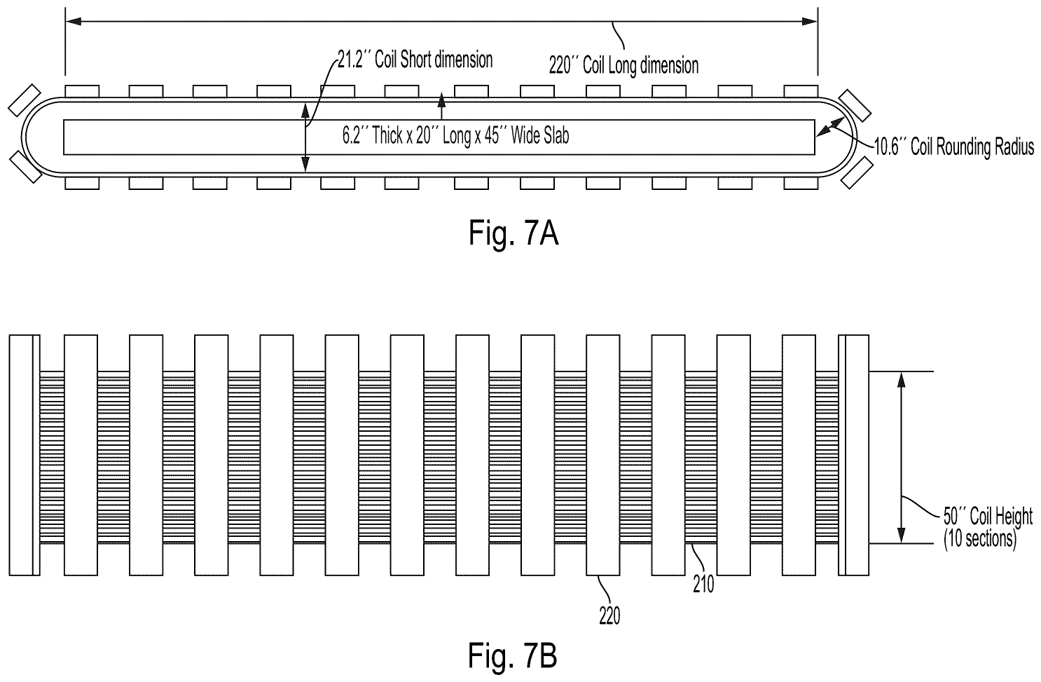

FIGS. 7A and 7B show, as a mere example, dimensions of one implementation of an induction slab heating system 200 according to the presently described embodiments. As shown, the example slab (6.2-inches thick by 220-inches long by 45-inches wide) 205 is moved into an induction slab heating system 200 that is 50-inches in height by 220-inches long with a 10.6-inch rounding radius.

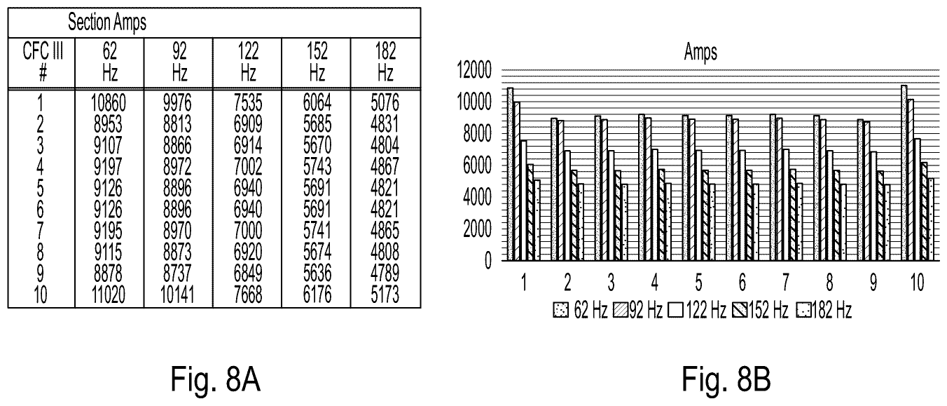

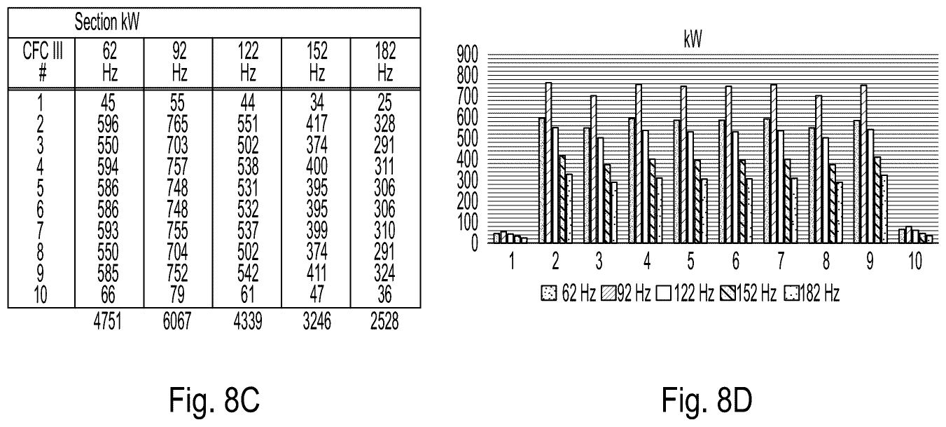

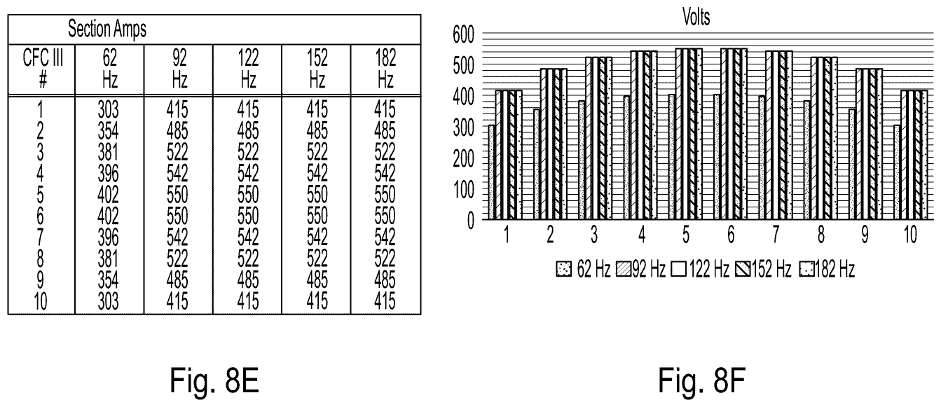

FIGS. 8A-8F illustrate heating recipes that could be implemented according to the presently described embodiments. Note that the bar charts of FIGS. 8B, 8D, and 8F are organized so that, for each zone 1-10, the data for each operating frequency (shown in order: 62 Hz, 92 Hz, 122 Hz, 152 Hz and 182 Hz) corresponds to an illustrated bar for that zone in that order. In at least one form of the presently described embodiments, the heating recipes are formulated to correspond to the geometries of the slabs being inductively heated. The heating recipes may be formulated in a variety of different manners. In at least one implementation, however, the heating recipes are predetermined, for example, based on simulation, training, sampled, historical or testing data. In other examples, the recipes may be formulated by using, for example, training runs of slabs in the heating system. Of course, other technical approaches such as machine learning, artificial intelligence, and other automated techniques may be used to formulate or assist with formulating the heating recipes.

As shown in FIGS. 8A-8F, a temperature result is achieved across the slab. In this regard, for example, this data illustrates that voltage can be applied at each frequency to gain a controlled result. The frequency for all coil zones can be adjusted using the inverters and the voltages can be adjusted on a per zone basis to likewise vary current and power. The heating profiles, depending on the desired result, according to the presently described embodiments, may generate a temperature gradient across the slab or generate uniform temperature across the slab.

According to the presently described embodiments, in as least one form, the different heights are accommodated by adjusting the number of zones that are used for a given slab geometry. In this regard, for example, zones can be “turned off” for slabs with less height. This is yet another advantage of the implementation of the presently described embodiments which, among other features, allows for a heating process that can be implemented on a per-zone basis.

Further, it will be appreciated that methods according to the presently described embodiments may be implemented in variety of manners, including those methods described herein such as the methods and techniques described in connection with the system described in connection with—FIGS. 1A-8F. As an example, in operation, an example method comprises detecting the slab 205 having a geometry positioned in the coil 210 having a plurality of zones, retrieving a heating recipe for the slab 205 based on the geometry of the slab 205, implementing a heating process based on the heating recipe, and selectively adjusting at least one of power, heating time or frequency of the plurality of zones of the coil through corresponding power inverters, each power inverter corresponding to at least one coil section to define a zone of the plurality of zones of the coil 210, based on the heating recipe.

The method may be implemented to add or modify functionality. For example, the method may further comprise generating the heating recipe based on simulation or testing data. In some implementations, the method will include moving the slab 205 into the coil 210 or moving the coil 210 to be positioned around the slab 205. Further, in at least one form, the selectively adjusting at least one of power, heating time or frequency of the plurality of zones of the coil comprises selectively adjusting at least one of power, heating time or frequency of the plurality of zones of the coil in each of the plurality of the zones of the coil. In at least one form, the selectively adjusting the frequency of the plurality of zones of the coil comprises selectively adjusting the frequency to maintain all the plurality of the zones of the coil at the same frequency

In at least some forms, the heating recipe corresponds to a heating profile for the slab 205. In such cases, for example, the heating profile may generate uniform temperature across the slab 205 or the heating profile may generate a temperature gradient across the slab 205.

It should be appreciated the heating system 200 may take a variety of forms and be implemented in a variety of environments. In one aspect of the implementation described herein, the system 200 is provided with appropriate control and processing capability to provide processing and/or control to the systems and methods described herein, including in connection with FIGS. 1A-8F herein, as those of skill in the art will appreciate. As described, the system 200 includes the controller 230 comprising a processor 232 (or, in some example forms, multiple processors or other controllers) to control functions according to the presently described embodiments. The processor includes an interface 236 to receive data and information as well as other connections to, for example, the inverters or coil of the system 200.

Of course, a memory unit, or several memory units, are included in the system 200 including the memory 234 associated with the controller 230. In this regard, the presently described embodiments, in at least one example, include suitable software program(s) (e.g., instructions and/or code which are stored on the at least one memory) which, when executed by at least one processor, cause the processor and/or associated elements of the system to implement the method(s) according to the presently described embodiments.

It will be appreciated that the memory may take a variety of suitable forms to implement the presently described embodiments that will be apparent to those skilled in the art, including non-transitory computer readable media. The memory may be formed of separate elements, combined elements or appropriately distributed, depending on the application. The memory may also be provided integrally with processor or controller (or other processing elements) or fabricated and/or maintained separately therefrom.

Also, it will be appreciated that the structures and procedures shown above are only representative examples of embodiments that can be used to facilitate embodiments described above. In this regard, the various embodiments described in the examples above may be implemented using any suitable circuitry, hardware, and/or software modules that interact to provide particular results. One of skill in the computing arts can readily implement such described functionality, either at a modular level or as a whole, using knowledge generally known in the art. For example, the methods described herein may be used to create computer-readable instructions/code for execution by a processor. Such instructions may be stored on a non-transitory computer-readable medium and transferred to, for example, the processor for execution as is known in the art.

In this regard, it should be appreciated that the processor and/or controller is merely an example—it may take a variety of forms. For example, the above-described methods and/or techniques can be implemented on a system using well-known computer processors, memory units, storage devices, computer software, and other components. As shown in the example representation of such a system, the system includes at least one processor which receives data at an input module and controls the overall operation of the system by executing computer program instructions which define such operation. The computer program instructions may be stored in at least one storage device or memory (e.g., a magnetic disk or any other suitable non-transitory computer readable medium or memory device) and loaded into another memory (not shown) (e.g., a magnetic disk or any other suitable non-transitory computer readable medium or memory device), or another segment of memory, when execution of the computer program instructions is desired. Thus, the methods described herein may be defined by the computer program instructions stored in the memory and controlled by the processor executing the computer program instructions.

Also, according to various embodiments, merely an example representation of possible components of a system including a processor for illustrative purposes are described. Of course, the system may include other components. Also, the system is illustrated as primarily a single system. However, the system may be implemented as more than one device or system and, in some forms, may be a modular or distributed system with components or functions suitably distributed in, for example, a network or in various locations.

The exemplary embodiments have been described with reference to example elements, configurations, and techniques. Obviously, modifications and alterations to the exemplary embodiments will occur to others upon reading and understanding the preceding detailed description. It is intended that the exemplary embodiments be construed as including all such modifications and alterations insofar as they come within the scope of the appended claims or the equivalents thereof.

1. An induction slab heating system comprising;
a coil having a plurality of sections;
a plurality of power inverters, each power inverter corresponding to at least one section of the plurality of sections of the coil to define a zone of a plurality of zones of the coil;
a plurality of magnetic flux concentrators positioned around the coil;
and,
a controller comprising at least one processor and at least one memory having stored therein code or instructions that, when executed, cause the system to:
detect a slab having a geometry positioned in the coil;
retrieve a heating recipe for the slab based on the geometry of the slab;
implement a heating process based on the heating recipe; and,
selectively adjust at least one of power, heating time or frequency of the plurality of zones of the coil based on the heating recipe.

2. The system as set forth in claim 1 wherein the heating recipes are predetermined based on simulation or testing data.

3. The system as set forth in claim 1 wherein the slab is moved into the coil.

4. The system as set forth in claim 1 wherein the coil is moved to surround the slab.

5. The system as set forth in claim 1 wherein the heating recipe corresponds to a heating profile for the slab.

6. The system as set forth in claim 5 wherein the heating profile generates uniform temperature across the slab.

7. The system as set forth in claim 5 wherein the heating profile generates a temperature gradient across the slab.

8. The system as set forth in claim 1 wherein selectively adjusting at least one of power, heating time or frequency of the plurality of zones of the coil comprises selectively adjusting at least one of power, heating time or frequency of the plurality of zones of the coil in each of the plurality of the zones of the coil.

9. The system as set forth in claim 1 wherein selectively adjusting the frequency of the plurality of zones of the coil comprises selectively adjusting the frequency to maintain all the plurality of the zones of the coil at the same frequency.

10. The system as set forth in claim 1 wherein the each power inverter is a solid state device.

11. An induction slab heating method comprising;
detecting a slab having a geometry positioned in a coil having a plurality of zones;
retrieving a heating recipe for the slab based on the geometry of the slab;
implementing a heating process based on the heating recipe; and,
selectively adjusting at least one of power, heating time or frequency of the plurality of zones of the coil, each power inverter corresponding to at least one coil section to define a zone of the plurality of zones of the coil, based on the heating recipe.

12. The method as set forth in claim 11 further comprising generating the heating recipe based on simulation or testing data.

13. The method as set forth in claim 11 further comprising moving the slab into the coil.

14. The method as set forth in claim 11 further comprising moving the coil to be positioned around the slab.

15. The method as set forth in claim 11 wherein the heating recipe corresponds to a heating profile for the slab.

16. The method as set forth in claim 15 wherein the heating profile generates uniform temperature across the slab.

17. The method as set forth in claim 15 wherein the heating profile generates a temperature gradient across the slab.

18. The method as set forth in claim 11 wherein the selectively adjusting at least one of power, heating time or frequency of the plurality of zones of the coil comprises selectively adjusting at least one of power, heating time or frequency of the plurality of zones of the coil in each of the plurality of the zones of the coil.

19. The method as set forth in claim 11 wherein the selectively adjusting the frequency of the plurality of zones of the coil comprises selectively adjusting the frequency to maintain all the plurality of the zones of the coil at the same frequency.

20. A non-transitory computer readable medium having stored thereon code or instructions that, when executed by a processer, cause a system to;
detect a slab having a geometry positioned in a coil having a plurality of zones;
retrieve a heating recipe for the slab based on the geometry of the slab;
implement a heating process based on the heating recipe; and,
selectively adjust at least one of power, heating time or frequency of the plurality of zones of the coil, each power inverter corresponding to at least one coil section to define a zone of the plurality of zones of the coil, based on the heating recipe.
